(19) United States
(12) Patent Application Publication
(10) Pub. No.: US 2024/0006588 A1
(43) Pub. Date: Jan. 4, 2024

(54) ANODE FOR SECONDARY BATTERY AND SECONDARY BATTERY INCLUDING THE SAME

(71) Applicant: SK On Co., Ltd., Seoul (KR)

(72) Inventors: Jeong A KIM, Daejeon (KR); Byoung Ho KO, Daejeon (KR)

(21) Appl. No.: 18/346,525

(22) Filed: Jul. 3, 2023

(30) Foreign Application Priority Data
Jul. 4, 2022 (KR) 10-2022-0081978

(51) Int. Cl. H01M 4/36; H01M 10/0525; H01M 4/38; H01M 4/66; H01M 4/62; H01M 4/133

(52) U.S. Cl. CPC H01M 4/364; H01M 10/0525; H01M 4/386; H01M 4/661; H01M 4/625; H01M 4/133; H01M 2004/021

(57) ABSTRACT

The present disclosure provides an anode for a secondary battery, the anode including: an anode current collector; a first anode mixture layer provided on at least one surface of the anode current collector; a second anode mixture layer provided on the first anode mixture layer; and a third anode mixture layer provided on the second anode mixture layer, wherein each of the anode mixture layers includes a Si-containing anode active material and carbon nanotubes, and the number of walls of each of first carbon nanotubes included in the first anode mixture layer, second carbon nanotubes included in the second anode mixture layer, and third carbon nanotubes included in the third anode mixture layer satisfies a relation of [first carbon nanotubes<second carbon nanotubes<third carbon nanotubes].

### CROSS-REFERENCE TO RELATED APPLICATION(S)

This application claims benefit of priority to Korean Patent Application No. 10-2022-0081978 filed on Jul. 4, 2022 in the Korean Intellectual Property Office, the disclosure of which is incorporated herein by reference in its entirety.

### BACKGROUND

### 1. Field

The present disclosure relates to an anode for a secondary battery and a secondary battery including the same.

### 2. Description of Related Art

Recently, in accordance with the development of technologies for mobile devices and an increase in demand for mobile devices, demand for batteries as an energy source has rapidly increased. Therefore, many studies on the batteries that may satisfy various needs have been conducted. In particular, studies on a lithium secondary battery having a high energy density and excellent lifespan and cycle characteristics as a power source for mobile devices including electric vehicles have been actively conducted.

A lithium secondary battery refers to a battery including a cathode including a cathode active material capable of intercalating/deintercalating lithium ions, an anode including an anode active material capable of intercalating/deintercalating lithium ions, and a non-aqueous electrolyte containing lithium ions in an anode assembly in which a microporous separator is interposed between the cathode and the anode.

As the anode active material, a lithium metal, a lithium alloy, crystalline or amorphous carbon, a carbon complex, a silicon-based active material, and the like have been used. Thereamong, a silicon-based active material, which is an anode active material containing silicon (Si), may improve a capacity of a secondary battery and may provide high energy density, and thus, the silicon-based active material may be used alone or in combination with other anode active materials.

However, as the secondary battery is repeatedly charged and discharged, a phenomenon in which a volume of the silicon-based active material contracts and expands occurs, and as a result, the existing conductive path is destroyed, which causes deterioration of lifespan characteristics of the battery.

In order to prevent the problem caused by the contraction and expansion of the volume of the silicon-based active material, Korean Patent Laid-Open Publication No. 2016-0027364 and the like suggest applying a conductive agent such as a carbon nanotube. However, since carbon nanotubes have a larger specific surface area than a conventional spherical conductive agent such as graphite or carbon black powder, when a slurry is prepared by mixing carbon nanotubes as a conductive agent with an anode active material, a process of pre-dispersing the carbon nanotubes and mixing the carbon nanotubes with the anode active material is required.

The process of pre-dispersing carbon nanotubes has a problem in that a solids content, in particular, a content of the anode active material, is reduced compared to an anode slurry using graphite as an anode active material without using a silicon-based active material.

Furthermore, the reduction in solids content accelerates a migration phenomenon in which a conductive agent and a binder move to the top of the anode in a drying process, such that the resistance of the anode is increased, and adhesive properties are deteriorated, resulting in anode surface defects.

Accordingly, there is a demand for development of an anode for a secondary battery that may secure an appropriate level of conductivity, and at the same time, may increase a solids content in an anode slurry to minimize a migration phenomenon of a binder and a conductive agent and anode surface defects when a silicon-based active material is included.

### SUMMARY

An aspect of the present disclosure may prevent, in an anode including a silicon-based active material, anode surface defects due to volume expansion of a silicon-based active material, a reduction in solids content in a slurry due to addition of carbon nanotubes, and a migration phenomenon of a conductive agent and a binder.

According to an aspect of the present disclosure, an anode for a secondary battery may include: an anode current collector; a first anode mixture layer provided on at least one surface of the anode current collector; a second anode mixture layer provided on the first anode mixture layer; and a third anode mixture layer provided on the second anode mixture layer, wherein each of the anode mixture layers includes a Si-containing anode active material and carbon nanotubes, and the number of walls of each of first carbon nanotubes included in the first anode mixture layer, second carbon nanotubes included in the second anode mixture layer, and third carbon nanotubes included in the third anode mixture layer satisfies a relation of first carbon nanotubes<second carbon nanotubes<third carbon nanotubes.

A content of the carbon nanotubes included in each of the first anode mixture layer, the second anode mixture layer, and the third anode mixture layer based on the total weight of each of the anode mixture layers may satisfy a relation of first anode mixture layer second anode mixture layer third anode mixture layer.

Based on the total weight of each of the anode mixture layers, the first carbon nanotubes may be included in the first anode mixture layer in an amount of 0.5 to 2 wt %, the second carbon nanotubes may be included in the second anode mixture layer in an amount of 2 to 4 wt %, and the third carbon nanotubes may be included in the third anode mixture layer in an amount of 4 to 6 wt %.

The first carbon nanotube may be a single-walled carbon nanotube having one or two walls, the second carbon nanotube may be a thin-walled carbon nanotube having three to seven walls, and the third carbon nanotube may be a multi-walled carbon nanotube having eight or more walls.

A specific surface area of the first carbon nanotubes may be 400 to 600 m²/g, a specific surface area of the second carbon nanotubes may be 200 to 500 m²/g, and a specific surface area of the third carbon nanotubes may be 150 to 300 m²/g.

An average diameter of the first carbon nanotubes may be 1 to 4 nm, an average diameter of the second carbon nanotubes may be 5 to 10 nm, and an average diameter of the third carbon nanotubes may be 7 to 15 nm.

A content of the Si-containing anode active material included in each of the layers based on the total weight of each of the anode mixture layers may satisfy a relation of first anode mixture layer second anode mixture layer third anode mixture layer.

The Si-containing anode active material may be included in the first anode mixture layer in an amount of 10 to 15 wt % with respect to the total weight of the first anode mixture layer, the Si-containing anode active material may be included in the second anode mixture layer in an amount of 5 to 10 wt % with respect to the total weight of the second anode mixture layer, and the Si-containing anode active material may be included in the third anode mixture layer in an amount of 1 to 5 wt % with respect to the total weight of the third anode mixture layer.

The Si-containing anode active material may be at least one selected from the group consisting of Si, a Si—C complex, SiOₓ (0<x<2), and a Si alloy.

The Si alloy may be an alloy of Si and at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, and Po.

The first anode mixture layer, the second anode mixture layer, and the third anode mixture layer may each independently further include a carbon-based anode active material and a binder.

The anode may further include at least one selected from the group consisting of a conductive agent and a thickener other than carbon nanotubes.

According to another aspect of the present disclosure, a secondary battery may include a cathode, an anode, and a separator interposed between the cathode and the anode, wherein the anode includes at least one of the anodes for a secondary battery as described above.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a graph illustrating changes in capacity retention rates up to 100 charge and discharge cycles of anodes 1 to 9 obtained in manufacture of a single-layer anode in Examples; and

FIG. 2 is a graph illustrating changes in capacity retention rates and changes in direct current internal resistance (DC-IR) retention rates up to 300 charge and discharge cycles of anodes 10 to 12 manufactured in Example 1 and Comparative Examples 1 and 2.

### DETAILED DESCRIPTION

Hereinafter, preferred exemplary embodiments in the present disclosure will be described. However, the exemplary embodiments in the present disclosure may be modified to have several other forms, and the scope of the present disclosure is not limited to exemplary embodiments to be described below.

According to an aspect of the present disclosure, in manufacturing an anode including a silicon-containing anode active material, an anode including the silicon-containing anode active material and carbon nanotubes is provided in order to solve the problem of electrode surface defects due to a change in volume caused by contraction and expansion of the silicon-containing anode active material.

Specifically, as the anode according to the present disclosure, a multi-layer anode in which a plurality of anode mixture layers each including a silicon-containing anode active material and carbon nanotubes are formed on a surface of an anode current collector is provided.

The anode current collector is not particularly limited as long as it does not cause a chemical change in the battery and has high conductivity. Specifically, copper, stainless steel, nickel, titanium, calcined carbon, copper or stainless steel surface-treated with carbon, nickel, titanium, silver, or the like, or an aluminum-cadmium alloy may be used as the anode current collector.

As the anode current collector, an anode current collector having a thickness of 3 μm to 100 μm may be typically used. Specifically, the anode current collector may have a thickness of 4 μm to 40 μm to implement an anode having a small thickness. In addition, a binding force of the anode active material may be enhanced by forming fine irregularities on a surface of the anode current collector. For example, the anode current collector may be used in various forms such as a film, a sheet, a foil, a net, a porous structure, foam, and a non-woven fabric.

The anode may include a plurality of anode mixture layers formed on one surface or both surfaces of the anode current collector. The anode mixture layer is not particularly limited, but may be three or more layers. Specifically, the anode mixture layer includes a first anode mixture layer formed on an upper surface of the anode current collector, a second anode mixture layer formed on the first anode mixture layer, and a third anode mixture layer formed on the second anode mixture layer.

Each of the anode mixture layers includes a silicon-containing anode active material as an anode active material, and carbon nanotubes as a conductive agent, may further include an anode active material and a conductive agent commonly used in an anode for a secondary battery in addition to the silicon-containing anode active material and the carbon nanotubes, and may also include a binder.

The silicon-containing anode active material is capable of intercalating and deintercalating lithium ions, and is not particularly limited as long as it contains Si, and examples thereof include Si, SiOₓ (0<x<2), a SiC complex, and a Si alloy.

Since SiO₂ does not react with lithium ions and may not store lithium, x is preferably within the above range. Furthermore, the Si alloy is a Si-Q alloy, and Q may be an element selected from the group consisting of an alkali metal, an alkaline earth metal, a Group 13 element, a Group 14 element, a Group 15 element, a Group 16 element, a transition metal, a rare earth element, and a combination thereof other than Si, and specifically, may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-containing anode active material is not particularly limited, but an average particle diameter (D₅₀) thereof may be 1 μm to 10 μm, and specifically, may be 2 μm to 6 μm. When the particle diameter of the silicon-containing anode active material satisfies the above range, structural stability of the active material during charging and discharging may be promoted, a conductive network for maintaining electrical conductivity may be more smoothly formed, and accessibility to a binder for binding between active materials or between an active material and a current collector may be more easily achieved.

The silicon-containing anode active material is included in first to third layers, and the silicon-containing anode active material included in each of the layers may be included in an amount that increases as a distance from the anode current collector toward a surface of the anode increases in a thickness direction.

More specifically, based on the total weight of each of the anode mixture layers, a content of the silicon-containing anode active material included in the first anode mixture layer may be the highest, a content of the silicon-containing anode active material included in the third anode mixture layer may be the lowest, and a content of the silicon-containing anode active material included in the second anode mixture layer may be equal to or less than the content of the silicon-containing anode active material included in the first anode mixture layer and may be equal to or more than the content of the silicon-containing anode active material included in the third anode mixture layer.

It may be represented by the following relational expression.

First anode mixture layer Second anode mixture layer≥Third anode mixture layer

Specifically, the Si-containing anode active material may be included in the first anode mixture layer in an amount of 10 to 15 wt %, the Si-containing anode active material may be included in the second anode mixture layer in an amount of 5 to 10 wt %, and the Si-containing anode active material may be included in the third anode mixture layer in an amount of 1 to 5 wt %.

In general, when a silicon-containing anode active material is included, a silicon-based active material is applied to an electrode surface due to a problem that causes defects on the electrode surface such as peeling from an electrode current collector caused by contraction and expansion of the volume, and carbon nanotubes are also used as a conductive agent. However, according to the present disclosure, the above problem may be solved by controlling the type and/or content of carbon nanotubes used in each of the layers while applying a silicon-containing anode active material to a surface of the anode as well as to the electrode mixture layer close to the electrode current collector.

Therefore, in an exemplary embodiment in the present disclosure, each of the anode mixture layers includes carbon nanotubes as a conductive agent, and each of the anode mixture layers may include carbon nanotubes having different numbers of walls.

Specifically, a first carbon nanotube having a small number of walls may be added to the first anode mixture layer formed on the anode current collector, a third carbon nanotube having a large number of walls may be added to the third anode mixture layer, and a second carbon nanotube in which the number of walls is greater than the number of walls of the first carbon nanotube and is smaller than the number of walls of the third carbon nanotube may be added to the second anode mixture layer.

It may be represented by the following relational expression.

First carbon nanotube<Second carbon nanotube<Third carbon nanotube

As described above, the carbon nanotubes are not particularly limited as long as carbon nanotubes in which the number of walls decreases from the anode mixture layer close to the anode current collector toward the surface are used.

Although not limited thereto, for example, the first carbon nanotube may be a carbon nanotube having one or two walls, the second carbon nanotube may be a carbon nanotube having three to seven walls, and the third carbon nanotube may be a carbon nanotube having eight or more walls, and more specifically, eight to thirty walls.

Hereinafter, for convenience of distinction, the first carbon nanotube included in the first anode mixture layer formed on the anode current collector is referred to as a single-walled carbon nanotube (SWCNT), the second carbon nanotube included in the second anode mixture layer is referred to as a thin-walled carbon nanotube (TWCNT), and the third carbon nanotube included in the third anode mixture layer is referred to as a multi-walled carbon nanotube (MWCNT).

Each of the carbon nanotubes is not particularly limited, but a specific surface area and an average diameter of the first carbon nanotubes may be 40 to 600 m²/g and 1 to 4 nm, respectively. A specific surface area and an average diameter of the second carbon nanotubes may be 200 to 500 m²/g and 5 to 10 nm, respectively. In addition, a specific surface area and an average diameter of the third carbon nanotubes may be 150 to 300 m²/g and 7 to 15 nm, respectively. As the specific surface area increases, the conductivity may be secured with a small amount of carbon nanotubes, and as the average diameter decreases, excellent flexibility of the conductive agent may be obtained. Therefore, carbon nanotubes having specific surface areas and average diameters within the above ranges may be used. However, when carbon nanotubes having smaller diameters and larger specific surface areas than the above ranges are used, it may be difficult to secure dispersibility.

Carbon nanotubes have excellent electrical conductivity and a large specific surface area as the number of walls decreases, such that an electron conduction network between carbon nanotubes may be maintained. Due to such excellent network characteristics, it is possible to minimize the problem of the change in conductive path and the anode surface defects such as peeling from the anode current collector caused by the volume expansion of the silicon-containing anode active material.

Therefore, even when a large amount of silicon-containing anode active material is included in the first anode mixture layer close to the anode current collector, the first carbon nanotubes having a small number of walls are included, such that the problems caused by volume expansion of the silicon-containing anode active material due to the formation of the network between the carbon nanotubes may be minimized, and a long-term electrode lifespan may be secured. Furthermore, an effect of increasing a battery capacity may be secured by including a small amount of carbon nanotubes.

Meanwhile, in the second anode mixture layer of the anode according to an exemplary embodiment in the present disclosure, the amount of silicon-containing anode active material used is reduced compared to the first anode mixture layer, and the second carbon nanotubes having a greater number of walls than the first carbon nanotubes are used for the carbon nanotubes used together, such that the problems such as electrode surface defects caused by the silicon-containing anode active material may be reduced.

In addition, in the third anode mixture layer, the amount of silicon-containing anode active material used is reduced compared to the second anode mixture layer, such that the problems such as the electrode surface defects caused by the silicon-containing anode active material may be reduced, and the third carbon nanotubes having a larger number of walls are used, such that the problems such as the electrode surface defects caused by the silicon-containing anode active material may be prevented.

The problems caused by contraction and expansion of the volume of the silicon-containing anode active material may be further suppressed by controlling the content of carbon nanotubes added to each of the anode mixture layers. As an example, as for the content of carbon nanotubes included in each of the anode mixture layers, based on the total weight of each of the anode mixture layers, a content of the first carbon nanotubes included in the first anode mixture layer may be the smallest, a content of the third carbon nanotubes included in the third anode mixture layer may be the largest, and a content of the second carbon nanotubes included in the second anode mixture layer may be equal to or more than the content of the first carbon nanotubes of the first anode mixture layer and may be equal to or less than the content of the third carbon nanotubes of the third anode mixture layer.

As described above, since the first carbon nanotube having a small number of walls has excellent conductivity and is easy to form a network between the carbon nanotubes, even though a large amount of silicon-containing anode active material is used, the problems caused by the volume expansion of the silicon-containing anode active material may be prevented even when a small amount of the first carbon nanotubes is used. However, as the number of walls of carbon nanotubes increases, the conductivity is reduced, and an ability to form a network between the carbon nanotubes decreases. Therefore, even though a relatively small amount of silicon-containing anode active material is used, it is preferable to use a larger amount of carbon nanotubes to prevent the problems caused by the volume expansion of the silicon-containing anode active material.

More specifically, the first carbon nanotubes may be included in an amount of 0.5 to 2 wt % based on the total weight of the first anode mixture layer, the second carbon nanotubes may be included in an amount of 2 to 4 wt % based on the total weight of the second anode mixture layer, and the third carbon nanotubes may be included in an amount of 4 to 6 wt % based on the total weight of the third anode mixture layer.

In the multi-layer anode manufactured by the present disclosure, a thickness ratio of each of the anode mixture layers is not particularly limited, and may be controlled according to the content of the silicon-containing anode active material added to each layer. For example, a thickness of the layer having a high content of the silicon-containing anode active material may be larger, and a thickness of the layer having a low content of the silicon-containing anode active material may be smaller, and the thickness of the anode mixture layer may satisfy a relation of first anode mixture layer second anode mixture layer third anode mixture layer. More specifically, the thicknesses of the first anode mixture layer, the second anode mixture layer, and the third anode mixture layer may not be the same, and may have, for example, a thickness ratio of 1.2 to 5:1.1 to 3:1 while satisfying the above relation.

The first anode mixture layer to the third anode mixture layer according to the present disclosure may further include a commonly used anode active material, a binder, and the like, in addition to the silicon-containing anode active material and the carbon nanotubes described above, and if necessary, may further include additives such as a conductive agent and a thickener.

The anode active material may be suitably used in the present disclosure as long as it has a function of intercalating and deintercalating lithium ions, and for example, a carbon-based active material may be used, amorphous, planar, flaky, spherical, or fibrous natural graphite or artificial graphite may be used, or a mixture of artificial graphite and natural graphite may be used. When the mixture of artificial graphite and natural graphite is used, although not particularly limited, the artificial graphite and the natural graphite may be mixed at a weight ratio of, for example, 70:30 to 95:5. Furthermore, the carbon-based active material may be crystalline carbon, amorphous carbon such as soft carbon or hard carbon, or a combination thereof.

In addition, the anode active material may further include at least one of a tin (Sn)-based anode active material or a lithium vanadium oxide anode active material. The Sn-based anode active material may be Sn, SnO₂, or a Sn—R alloy. In the Sn—R alloy, R may be selected from the group consisting of an alkali metal, an alkaline earth metal, a Group 13 element, a Group 14 element, a Group 15 element, a Group 16 element, a transition metal, a rare earth element, and a combination thereof other than Sn and Si, and specifically, may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, In, Tl, Ge, P, As, Sb, Bi, S, Se, Te, Po, and a combination thereof.

When the anode active material further includes the Sn-based anode active material, the Sn-based anode active material may be included in an amount of 1 to 50 wt % with respect to the total weight of the anode active material.

A content of the anode active material in the anode mixture layer may be 94 to 98 wt % with respect to the total weight of the anode mixture layer.

A binder serves to bind anode active material particles to each other and to bind the anode active material to the anode current collector, and a commonly used binder may be used. Examples of the binder include, but are not limited to, polyvinyl alcohol, carboxymethyl cellulose, hydroxypropyl cellulose, diacetyl cellulose, polyvinyl chloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, and nylon.

A content of the binder may be 1.5 to 3 wt % with respect to the total weight of the anode mixture layer.

The anode mixture layer may further include a thickener for imparting viscosity along with the binder. As the thickener, a cellulose-based compound may be used, and for example, a mixture of one or more of carboxymethyl cellulose, hydroxypropyl methyl cellulose, methyl cellulose, and an alkali metal salt thereof may be used. Na, K, or Li may be used as the alkali metal.

The thickener may be used in an amount of 0.1 parts by weight to 3 parts by weight with respect to 100 parts by weight of the anode active material. The conductive agent is used to impart conductivity to the electrode and is not particularly limited as long as it is commonly used in a secondary battery, and for example, a conductive material including a carbon-based material such as natural graphite, artificial graphite, carbon black, acetylene black, Ketjen black, a carbon fiber, or a carbon nanotube; a metallic material of a metal powder or a metal fiber such as copper, nickel, aluminum, or silver, a conductive polymer such as a polyphenylene derivative; and a mixture thereof may be used.

A content of the conductive agent may be 0.1 to 3 wt % with respect to the total weight of the anode mixture layer.

The carbon nanotubes have a larger specific surface area than a spherical conductive agent. Therefore, an additional pre-treatment may be performed to improve dispersibility of the carbon nanotubes in an anode slurry. For example, a pre-dispersion may be prepared by dispersing the carbon nanotubes in a solvent together with a dispersant, an additive, and the like. The solvent is not particularly limited, and a known solvent may be used.

Furthermore, in preparing the pre-dispersion, a dispersant and an additive may be further included together with the carbon nanotubes and the solvent. The dispersant and the additive are not particularly limited, and a known dispersant and additive may be used.

The prepared carbon nanotube pre-dispersion may be mixed with a silicon-based active material, an anode active material, and a binder, and if necessary, a conductive agent and a thickener, and a solvent, thereby preparing an anode slurry.

The pre-dispersion may have a solids content of 0.5 to 40 wt %. The solids content in the pre-dispersion refers to the weight of components other than the solvent with respect to the total weight of the pre-dispersion. As the number of walls of the carbon nanotubes increases, the solids content in the pre-dispersion increases.

An anode may be manufactured by applying the anode slurry to one surface or both surfaces of the anode current collector and then performing drying and rolling.

In the present disclosure, in manufacturing an electrode by preparing a slurry for forming each of the first to third anode mixture layers, applying the slurry to the anode current collector, and performing drying and rolling, an anode slurry for forming the first anode mixture layer is applied and dried, an anode slurry for forming the second anode mixture layer is applied and dried, an anode slurry for forming the third anode mixture layer is applied and dried, and then rolling is performed, thereby manufacturing an anode, and the respective anode slurries are continuously or intermittently applied, and then the applied anode slurries are simultaneously dried and rolled to manufacture an anode.

As described above, in the case in which an anode is manufactured by individually applying and drying the anode slurry to form each anode mixture layer, a migration phenomenon of the binder and the like may be suppressed during the drying process, and in the case in which each of the anode slurries is applied, and then the applied anode slurries are simultaneously dried, the process may be simplified.

A method of applying the anode slurry is not particularly limited, and a known method may be used. For example, the anode slurry is distributed on the anode current collector, and then the anode slurry may be uniformly dispersed using a doctor blade or the like. In some cases, a method of performing the distribution and dispersion processes as one process may be used. In addition, methods such as die casting, comma coating, gravure coating, and screen printing may be applied.

As described above, according to an exemplary embodiment in the present disclosure, in applying carbon nanotubes as a conductive agent while using a silicon-containing anode active material, a multi-layer electrode is manufactured by simultaneously or individually controlling the type and content of carbon nanotubes according to the position in the thickness direction based on the current collector, such that the total content of the anode, in particular, the content of the anode active material may be increased, thereby improving the capacity of the battery.

In addition, although a large amount of silicon-containing anode active material is used in the first anode mixture layer, a binding force of the anode mixture layer to the anode current collector may be improved by specializing carbon nanotubes, and the electrode surface defects may be suppressed. In addition, the migration phenomenon of the binder or the conductive agent in the mixture layer may be improved.

Furthermore, relatively inexpensive thin-walled carbon nanotubes or multi-walled carbon nanotubes are used instead of expensive single-walled carbon nanotubes for the second anode mixture layer and the third anode mixture layer, such that it is possible to improve the surface quality of the anode and to secure the effect of extending the battery capacity and lifespan.

Another aspect of the present disclosure provides a secondary battery including the anode for a secondary battery, a cathode in which a cathode mixture layer including a cathode active material is formed on a cathode current collector, a separator, and an electrolyte.

The separator separates an anode and a cathode, and provides a migration path for lithium ions, and is not particularly limited as long as it is commonly used as a separator in a secondary battery. Particularly, a separator having low resistance against ion migration of an electrolyte and having excellent moisture-retention ability for an electrolyte is preferable. Specifically, a porous polymer film, for example, a porous polymer film formed of a polyolefin-based polymer, such as an ethylene homopolymer, a propylene homopolymer, an ethylene/butene copolymer, an ethylene/hexene copolymer, or an ethylene/methacrylate copolymer, or a laminate structure having two or more layers thereof may be used. Alternatively, a common porous non-woven fabric, for example, a non-woven fabric formed of high melting point glass fibers or polyethylene terephthalate fibers may be used. In addition, in order to secure heat resistance or mechanical strength, a coated separator including a ceramic component or a polymer material may be used, and these separators may optionally have a single-layer or multi-layer structure.

Examples of the electrolyte include, but are not limited to, an organic liquid electrolyte, an inorganic liquid electrolyte, a solid polymer electrolyte, a gel polymer electrolyte, a solid inorganic electrolyte, and a molten inorganic electrolyte, which may be used in manufacturing a secondary battery.

### EXAMPLES

Hereinafter, Examples of the present disclosure will be described in detail. However, the following Examples are provided only for assisting in the understanding of the present disclosure, but are not intended to limit the present disclosure.

Preparation of Pre-Dispersion

Under the conditions as shown in Table 1, pre-dispersions in which single-walled carbon nanotubes (SWCNTs) having one or two walls, thin-walled carbon nanotubes (TWCNTs) having three to seven walls, and multi-walled carbon nanotubes (MWCNTs) having eight to thirty walls were dispersed in an NMP solvent were prepared, respectively (pre-dispersions 1 to 3).

TABLE 1

| | | Carbon nanotubes | | | |
|---|---|---|---|---|---|
| | Solvent | | | Specific | Average |
| | Content | Content | | surface area | diameter |
| | (wt %) | (wt %) | Type | (m²/g) | (nm) |
| Pre-dispersion | 99 | 1 | SWCNT | 500 | 2 um |
| 1 | | | | | |
| Pre-dispersion | 97 | 3 | TWCNT | 250 | 9 um |
| 2 | | | | | |
| Pre-dispersion | 95 | 5 | MWCNT | 180 | 13 um |
| 3 | | | | | |

Manufacture of Single-Layer Anode

In order to confirm the slurry and electrode characteristics according to the characteristics of the carbon nanotubes when SiOₓ was used as an anode active material, as shown in Table 2, the prepared pre-dispersion, SiOₓ (0<x<2) and graphite as anode active materials, styrene-butadiene rubber (SBR) as a binder, and carboxymethyl cellulose (CMC) as a thickener were mixed, and water as a solvent was added, thereby preparing anode slurries (slurries 1 to 9).

TABLE 2

| | | CNT pre-dispersion | | | | | |
|---|---|---|---|---|---|---|---|
| Content | | | CNT | | | | |
| (wt %) | SiOₓ | Type | content | Graphite | SBR | CMC | Reference |
| Slurry 1 | 15 | Pre- | 0.5 | 81.2 | 2.0 | 1.3 | Anode 1 |
| | | dispersion 1 | | | | | |
| Slurry 2 | 15 | Pre- | 2 | 79.7 | 2.0 | 1.3 | Anode 2 |
| | | dispersion 1 | | | | | |
| Slurry 3 | 15 | Pre- | 4 | 77.7 | 2.0 | 1.3 | Anode 3 |
| | | dispersion 1 | | | | | |
| Slurry 4 | 10 | Pre- | 2 | 84.7 | 2.0 | 1.3 | Anode 4 |
| | | dispersion 2 | | | | | |
| Slurry 5 | 10 | Pre- | 4 | 82.7 | 2.0 | 1.3 | Anode 5 |
| | | dispersion 2 | | | | | |
| Slurry 6 | 10 | Pre- | 6 | 80.7 | 2.0 | 1.3 | Anode 6 |
| | | dispersion 2 | | | | | |
| Slurry 7 | 5 | Pre- | 2 | 89.7 | 2.0 | 1.3 | Anode 7 |
| | | dispersion 3 | | | | | |
| Slurry 8 | 5 | Pre- | 6 | 85.7 | 2.0 | 1.3 | Anode 8 |
| | | dispersion 3 | | | | | |
| Slurry 9 | 5 | Pre- | 10 | 81.7 | 2.0 | 1.3 | Anode 9 |
| | | dispersion 3 | | | | | |

Each of the prepared anode slurries was applied on a copper plate having a thickness of 10 μm as an anode current collector, and drying was performed at 80° C. for 1 hour, and then rolling was performed to have a density of 1.5 g/cc, thereby manufacturing a single-layer anode having a thickness of 121 μm.

Subsequently, the manufactured anode was subjected to a heat treatment in a vacuum atmosphere at 80° C. for 12 hours or longer.

Measurement of Slurry Resistance

The resistance of each slurry shown in Table 2 was measured by the following method. The results thereof are shown in Table 3.

Slurry resistance measurement method: The first slurry prepared in each of Preparation Example 1 and Comparative Preparation Examples 1 and 2 was applied to a PET film, and drying was performed at a temperature of 100° C. for 30 minutes. The slurry resistance was measured by the 4-probe method.

Manufacture of Coin Cell

Electrode assemblies were manufactured using each of the manufactured anode, a cathode, and a separator (trade name: 525HV, manufactured by SK IE Technology Co., Ltd.) having a thickness of 25 μm, an electrolyte was injected into the electrode assemblies, and then the resulting electrode assemblies were compressed, thereby manufacturing coin cells (coin cells 1 to 9).

Measurement of Capacity Retention Rate

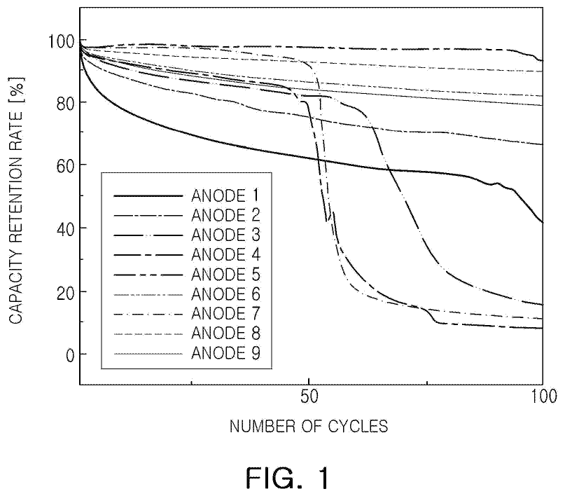

The manufactured coin cell was charged at C-rate of 0.3 C and discharged at C-rate of 0.5 C at 25° C., and a capacity retention rate (%) in 100 cycles was evaluated. The results are shown in Table 3. In addition, the results of measuring the capacity retention rate of Table 3 are also illustrated in FIG. 1.

TABLE 3

| Slurry resistance | | Capacity retention rate | | |
|---|---|---|---|---|
| Slurry type | Unit: Ω · cm | Anode type | Coin cell type | Unit: % |
| Slurry 1 | 0.322 | Anode 1 | Coin cell 1 | 42.3 |
| Slurry 2 | 0.246 | Anode 2 | Coin cell 2 | 66.3 |
| Slurry 3 | 0.227 | Anode 3 | Coin cell 3 | 15.6 |
| Slurry 4 | 0.279 | Anode 4 | Coin cell 4 | 8.0 |
| Slurry 5 | 0.263 | Anode 5 | Coin cell 5 | 93.1 |
| Slurry 6 | 0.261 | Anode 6 | Coin cell 6 | 81.6 |
| Slurry 7 | 0.497 | Anode 6 | Coin cell 7 | 11.0 |
| Slurry 8 | 0.365 | Anode 7 | Coin cell 8 | 89.5 |
| Slurry 9 | 0.349 | Anode 9 | Coin cell 9 | 78.9 |

As can be seen from Table 3, the slurry resistance values of the slurries 1 to 3 were 0.322, 0.246, and 0.227, respectively, which were low overall, and it could be appreciated that the slurry resistance decreased as the content of SWCNTs increased.

However, when the batteries were manufactured using the anodes manufactured using the slurries 1 to 3, the capacity retention rates of the batteries were 42.3%, 66.4%, 66.4%, and 15.6%, respectively, and thus, it was confirmed that the capacity retention rate significantly decreased when the content of SWCNTs was excessive. It is determined that when SWCNTs are excessively mixed, an imbalance of the conductive network in the electrode is caused by aggregation of the conductive agent, and the cell performance is rather deteriorated.

In addition, as illustrated in FIG. 1, in the case of the slurry 3, the capacity retention rate significantly decreased after about 60 cycles, and on the other hand, in the cases of the slurries 1 and 2, the capacity retention rate slowly decreased, but the capacity retention rate did not decrease rapidly.

From these results, it could be appreciated that, in the case in which the silicon-containing anode active material was included, when a small amount of SWCNTs was used, the slurry resistance was improved, and the capacity retention rate of the battery was improved, but when SWCNTs were excessively included, the capacity retention rate rather decreased, which was not preferable.

Meanwhile, the slurry resistance values of the slurries 4 to 6 were 0.279, 0.263, and 0.261 Ω·cm, respectively, which were low overall, and it could be appreciated that as the content of TWCNTs increased, the slurry resistance decreased. However, when the batteries were manufactured using the anodes manufactured using the slurries 4 to 6, the capacity retention rates of the batteries were 8.0%, 93.1%, and 81.6%, respectively. In addition, it could be appreciated from FIG. 1 that the slurry 4 exhibited a rapid decrease in capacity retention rate before reaching 50 cycles, and the slurries 5 and 6 exhibited high capacity retention rates.

From these results, it could be appreciated that in the case in which a Si-containing compound was included, the capacity retention rate improvement effect was not obtained by using a small amount of TWCNTs, but a high capacity retention rate improvement effect was obtained only by using a larger amount of TWCNTs than in the case of SWCNTs.

Further, the slurry resistance values of the slurries 7 to 9 were 0.479, 0.365, and 0.349, respectively, which were higher than those in the cases of using SWCNTs and TWCNTs, and it could be appreciated that as the content of MWCNTs increased, the slurry resistance decreased.

However, in the case in which the batteries were manufactured using the anodes manufactured using the slurries 7 to 9, the capacity retention rates of the batteries were 11.0%, 89.5%, and 78.9%, respectively, and as illustrated in FIG. 1, it could be appreciated that the slurry 7 exhibited a rapid decrease in capacity retention rate before reaching 50 cycles, but the slurries 5 and 6 exhibited high capacity retention rates.

From these results, it could be appreciated that despite the use of the smallest amount of Si-containing anode active material, a high capacity retention rate was secured only when the largest amount of MWCNTs was used relative to the content of the Si-containing anode active material.

From the evaluation results of the slurry resistance for each slurry and the capacity retention rate of the battery using the anode manufactured using the slurry, it could be appreciated that in the case of using a Si-containing anode active material, the solids content was increased by adding a small amount of SWCNTs, and the slurry resistance decreased, and even in the case of using TWCNTs, the slurry resistance was maintained relatively low as the solids content increased, and the capacity retention rate was improved. That is, compared to the solids content in the slurry when a single-layer anode was manufactured using only SWCNTs, in the case of manufacturing a multi-layer anode using different types of slurries including TWCNTs and MWCNTs together, as the solids content was increased, the processability was excellent in the manufacture of the electrode, the conductivity was excellent, and the capacity retention rate was improved.

Manufacture of Multi-Layer Anode

### Example 1

The slurry 2 was applied on a copper plate having a thickness of 10 μm, and drying was performed at 80° C. for 1 hour, thereby forming a first anode mixture layer. The slurry 5 was applied on the first anode mixture layer, and drying was performed in the same manner, thereby forming a second anode mixture layer on the first anode mixture layer. Subsequently, the slurry 8 was applied on the second anode mixture layer, drying was performed in the same manner to form a third anode mixture layer, and then rolling was performed to have an anode density of 1.5 g/cc, thereby manufacturing a multi-layer anode (anode 10) having a thickness of 121 μm. The respective slurries used in the anode 10 are shown in Table 4.

At this time, a thickness ratio of the first to third anode mixture layers as the respective anode mixture layers of the multi-layer anode was 2:1.5:1.

TABLE 4

| Content | | CNT pre-dispersion | | | | |
|---|---|---|---|---|---|---|
| (wt %) | SiOₓ | Type | CNT content | Graphite | SBR | CMC |
| Slurry 2 | 15 | Pre- | 2 | 79.7 | 2.0 | 1.3 |
| | | dispersion 1 | | | | |
| Slurry 5 | 10 | Pre- | 4 | 82.7 | 2.0 | 1.3 |
| | | dispersion 2 | | | | |
| Slurry 8 | 5 | Pre- | 6 | 85.7 | 2.0 | 1.3 |
| | | dispersion 3 | | | | |

Subsequently, the manufactured multi-layer anode was subjected to a heat treatment in a vacuum atmosphere at 80° C. for 12 hours or longer.

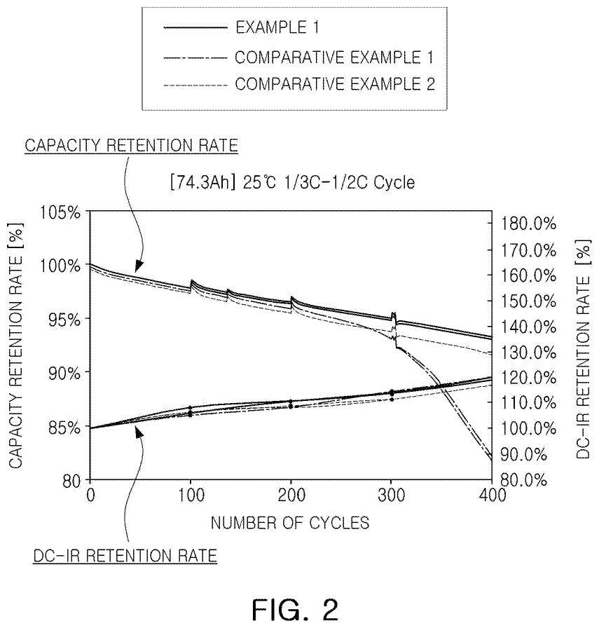

A coin cell (coin cell 10) was manufactured in the same manner as described above using the manufactured multi-layer anode, the capacity retention rate and the direct current internal resistance (DC-IR) retention rate up to 300 cycles were measured twice, respectively. The results thereof are shown in Table 7. In addition, the capacity retention rate and the DC-IR retention rate are illustrated in FIG. 2.

The DC-IR retention rate was measured by the following method.

DC-IR retention rate measurement method: The DC-IR retention rate was measured at SOC 50% by discharging the battery at 0.3 C to DOD 50%, allowing the battery to rest for 1 hour, and then discharging and charging the battery at 1 C for 10 seconds.

Further, the slurries 2, 5, and 8 were sequentially applied on a PET film, drying was performed, and the slurry resistance was measured in the same manner as described above. The results are shown in Table 7.

### Comparative Example 1

A multi-layer anode (anode 11) was manufactured in the same manner as that of Example 1, except that the slurries 10, 5, and 11 shown in Table 5 were sequentially applied on a copper plate having a thickness of 10 μm. The respective slurries used in the anode 11 are shown in Table 5.

At this time, the first to third anode mixture layers as the respective anode mixture layers of the multi-layer anode were the same in terms of thickness ratio.

TABLE 5

| Content | | CNT pre-dispersion | | Natural | | |
|---|---|---|---|---|---|---|
| (wt %) | SiOₓ | Type | CNT content | graphite | SBR | CMC |
| Slurry 10 | 10 | Pre- | 2 | 84.7 | 2.0 | 1.3 |
| | | dispersion 1 | | | | |
| Slurry 5 | 10 | Pre- | 4 | 82.7 | 2.0 | 1.3 |
| | | dispersion 2 | | | | |
| Slurry 11 | 10 | Pre- | 6 | 80.7 | 2.0 | 1.3 |
| | | dispersion 3 | | | | |

A coin cell (coin cell 11) was manufactured in the same manner as described above using the manufactured multi-layer anode, and the capacity retention rate and the DC-IR retention rate were measured twice, respectively. The measured capacity retention rate and DC-IR retention rate are shown in Table 7 and illustrated in FIG. 2.

Further, the slurries 10, 5, and 11 were sequentially applied on a PET film, drying was performed, and the slurry resistance was measured in the same manner as described above. The results are shown in Table 7.

### Comparative Example 2

A multi-layer anode (anode 12) was manufactured in the same manner as in the manufacture of the single-layer anode except for using the slurry 10. The slurry used in the anode 12 is shown in Table 6.

TABLE 6

| | | CNT pre-dispersion | | | | |
|---|---|---|---|---|---|---|
| Content | | | CNT | Natural | | |
| (wt %) | SiOₓ | Type | content | graphite | SBR | CMC |
| Slurry 10 | 10 | Pre-dispersion 1 | 2 | 84.7 | 2.0 | 1.3 |

A coin cell (coin cell 12) was manufactured in the same manner as described above using the manufactured single-layer anode, and the capacity retention rate and the DC-IR retention rate were measured twice, respectively. The measured capacity retention rate and DC-IR retention rate are shown in Table 7 and illustrated in FIG. 2.

Further, the slurry 10 was applied on a PET film, drying was performed, and the slurry resistance was measured in the same manner as described above. The results are shown in Table 7.

TABLE 7

| | | Slurry resistance | | | | | |
|---|---|---|---|---|---|---|---|
| | | Slurry | | | | | |
| | Solids | type | | | | | |
| | content | (one | | Coin cell | | | |
| | in | layer/two | | | Coin | Capacity | DC-IR |
| | slurry | layers/three | | Anode | cell | retention | retention |
| | (wt %) | layers) | Ω · cm | type | type | rate (%) | rate (%) |
| Example 1 | 47.3 | Slurry | 0.455 | Anode | Coin | 93.1 | 125.8 |
| | | 2/5/8 | | 10 | cell 10 | | |
| Comparative | 46.6 | Slurry | 0.517 | Anode | Coin | 81.9 | 124.9 |
| Example 1 | | 10/5/11 | | 11 | cell 11 | | |
| Comparative | 43.3 | Slurry | 0.492 | Anode | Coin | 91.6 | 125.6 |
| Example 2 | | 10 | | 12 | cell 12 | | |

As can be seen from Table 7, in the case of the anode of Example 1, the solids content in the slurry was high, the slurry resistance was low, and the capacity retention rate and the DC-IR contention rate were high compared to the anode of Comparative Example 1 or 2.

Specifically, in the case of the anode 10 of Example 1, in the first anode mixture layer formed on the anode current collector, the second anode mixture layer formed on the first anode mixture layer, and the third anode mixture layer formed on the second anode mixture layer, as the anode mixture layer was closer to the surface of the anode from the anode current collector, the content of the Si-containing anode active material was reduced, the number of walls of CNTs included in each of the anode mixture layers increased, and the distribution of the content of CNTs gradually increased, and although the content of CNTs included in the slurry used to manufacture the anode 10 was the same as those in Comparative Examples 1 and 2, the slurry resistance value was the lowest.

It was determined that the slurry resistance was low and the capacity retention rate was improved because the solids content in the slurry was increased by appropriately controlling the type of CNTs, resulting in suppression of the phenomenon in which the binder was biased to the surface of the anode due to the migration phenomenon of the binder during the drying process.

Further, in the case of the anode of Example 1, the capacity retention rate and the DC-IR retention rate were high, and in particular, the capacity retention rate was significantly high.

In Comparative Example 1, it could be confirmed that the total content of the Si-containing anode active material and CNTs was the same as that in Example 1, but since the content of CNTs in the first anode mixture layer was excessive compared to the content of the Si-containing anode active material as in the anode 3, as CNTs were aggregated, the electronic conduction network was not secured due to the volume expansion of the Si-containing anode active material, resulting in deterioration of the capacity retention rate of the battery.

Meanwhile, in Comparative Example 2, it could be confirmed that the conductivity of the anode was reduced due to high slurry resistance.

According to the present disclosure, when a multi-layer anode is manufactured by applying different types and contents of carbon nanotubes according to the content of the silicon-based active material, the solids content in the slurry is increased, and at the same time, the slurry resistance decreases, such that the conductivity may be secured, and the lifespan characteristics of the battery may be improved.

As set forth above, the anode for a secondary battery according to the present disclosure may prevent the problems of the anode surface defects caused by contraction and expansion of the silicon-containing anode active material.

Further, the anode for a secondary battery according to the present disclosure has an appropriate level of conductivity, and may prevent the migration phenomenon of the conductive agent and the binder by increasing the solids content in the anode slurry.

While exemplary embodiments have been shown and described above, it will be apparent to those skilled in the art that modifications and variations could be made without departing from the scope of the present disclosure as defined by the appended claims.

What is claimed is:

1. An anode for a secondary battery, comprising:
an anode current collector;
a first anode mixture layer provided on at least one surface of the anode current collector;
a second anode mixture layer provided on the first anode mixture layer; and
a third anode mixture layer provided on the second anode mixture layer,
wherein each of the anode mixture layers includes a Si-containing anode active material and carbon nanotubes, and
the number of walls of each of first carbon nanotubes included in the first anode mixture layer, second carbon nanotubes included in the second anode mixture layer, and third carbon nanotubes included in the third anode mixture layer satisfies the following relation:
first carbon nanotubes<second carbon nanotubes<third carbon nanotubes.

2. The anode of claim 1, wherein a content of the carbon nanotubes included in each of the first anode mixture layer, the second anode mixture layer, and the third anode mixture layer based on the total weight of each of the anode mixture layers satisfies the following relation:
first anode mixture layer≥second anode mixture layer≥third anode mixture layer.

3. The anode of claim 1, wherein based on the total weight of each of the anode mixture layers,
the first carbon nanotubes are included in the first anode mixture layer in an amount of 0.5 to 2 wt %,
the second carbon nanotubes are included in the second anode mixture layer in an amount of 2 to 4 wt %, and
the third carbon nanotubes are included in the third anode mixture layer in an amount of 4 to 6 wt %.

4. The anode of claim 1, wherein the first carbon nanotube is a single-walled carbon nanotube having one or two walls, the second carbon nanotube is a thin-walled carbon nanotube having three to seven walls, and the third carbon nanotube is a multi-walled carbon nanotube having eight or more walls.

5. The anode of claim 1, wherein a specific surface area of the first carbon nanotubes is 400 to 600 m²/g,
a specific surface area of the second carbon nanotubes is 200 to 500 m²/g, and
a specific surface area of the third carbon nanotubes is 150 to 300 m²/g.

6. The anode of claim 1, wherein an average diameter of the first carbon nanotubes is 1 to 4 nm,
an average diameter of the second carbon nanotubes is 5 to 10 nm, and
an average diameter of the third carbon nanotubes is 7 to 15 nm.

7. The anode of claim 1, wherein a content of the Si-containing anode active material included in each of the layers based on the total weight of each of the anode mixture layers satisfies the following relation:
first anode mixture layer≥second anode mixture layer≥third anode mixture layer.

8. The anode of claim 1, wherein the Si-containing anode active material is included in the first anode mixture layer in an amount of 10 to 15 wt % with respect to the total weight of the first anode mixture layer,
the Si-containing anode active material is included in the second anode mixture layer in an amount of 5 to 10 wt % with respect to the total weight of the second anode mixture layer, and
the Si-containing anode active material is included in the third anode mixture layer in an amount of 1 to 5 wt % with respect to the total weight of the third anode mixture layer.

9. The anode of claim 1, wherein the Si-containing anode active material is at least one selected from the group consisting of Si, a Si—C complex, SiOₓ (0<x<2), and a Si alloy.

10. The anode of claim 9, wherein the Si alloy is an alloy of Si and at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, and Po.

11. The anode of claim 1, wherein the first anode mixture layer, the second anode mixture layer, and the third anode mixture layer each independently further include a carbon-based anode active material and a binder.

12. The anode of claim 11, further comprising at least one selected from the group consisting of a conductive agent and a thickener other than carbon nanotubes.

13. A secondary battery comprising:
a cathode, an anode, and a separator interposed between the cathode and the anode,
wherein the anode includes the anode for a secondary battery of claim 1.
